(19) United States
(12) Patent Application Publication
(10) Pub. No.: US 2026/0368547 A1
(43) Pub. Date: Nov. 19, 2026

(54) WEIGHT PARAMETER OPTIMIZATION USING MIXED INTEGER PROGRAMMING

(71) Applicant: INTERNATIONAL BUSINESS MACHINES CORPORATION, Armonk, NY (US)

(72) Inventors: Deng Xin Luo, XIAN (CN); Rui Han, XIAN (CN); Qi Liang Zhou, XIAN (CN); Wen Jie Hao, XIAN (CN); Zhi Yong Jia, XIAN (CN)

(21) Appl. No.: 19/208,008

(22) Filed: May 14, 2025

(51) Int. Cl. G06N 3/0985; B60W 50/00; B60W 60/00

(52) U.S. Cl. CPC G06N 3/0985; B60W 50/00; B60W 60/00; B60W 2050/0028; B60W 2510/18; B60W 2510/20; B60W 2520/105

(57) ABSTRACT

Methods and systems include copying first parameters of a machine learning model into variables of a mixed integer programming problem, including at least one variable that is constrained to be an integer value. The mixed integer programming problem is solved according to an objective function and one or more additional constraints to generate trained variables. The trained variables are copied into the machine learning model to replace the first parameters and to create a trained machine learning model.

### BACKGROUND

The present invention generally relates to machine learning models and, more particularly, to parameter optimization using mixed integer programming.

Training a neural network model can include updating parameters of the model using a technique called backpropagation. Using a classification task as an example, training data is provided with predetermined class labels. The training data is processed by the model to predict a label. If the predicted label differs from the predetermined class label, the error is propagated back through the network to update the parameter weights. This is an iterative process, eventually producing a classifier model that can accurately predict labels for novel inputs.

### SUMMARY

A method includes copying first parameters of a machine learning model into variables of a mixed integer programming problem, including at least one variable that is constrained to be an integer value. The mixed integer programming problem is solved according to an objective function and one or more additional constraints to generate trained variables. The trained variables are copied into the machine learning model to replace the first parameters and to create a trained machine learning model.

A computer system includes a processor set, one or more computer-readable storage media, and program instructions stored on the one or more computer-readable storage media to cause the processor set to perform operations. The operations include copying first parameters of a machine learning model into variables of a mixed integer programming problem, including at least one variable that is constrained to be an integer value, solving the mixed integer programming problem, using a hardware processor, according to an objective function and one or more additional constraints to generate trained variables, and copying the trained variables into the machine learning model to replace the first parameters and to create a trained machine learning model.

A computer program product includes one or more computer-readable storage media and program instructions stored on the one or more computer-readable storage media to perform operations. The operations include copying first parameters of a machine learning model into variables of a mixed integer programming problem, including at least one variable that is constrained to be an integer value, solving the mixed integer programming problem, using a hardware processor, according to an objective function and one or more additional constraints to generate trained variables, and copying the trained variables into the machine learning model to replace the first parameters and to create a trained machine learning model.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing a system for machine learning model generation that uses mixed integer programming, in accordance with an embodiment of the present invention;

FIG. 2 is a block/flow diagram of a method for optimizing a machine learning model using mixed integer programming, in accordance with an embodiment of the present invention;

FIG. 3 is a block/flow diagram of a model for training and using a machine learning model with mixed integer programming optimization, in accordance with an embodiment of the present invention;

FIG. 4 is a diagram of an autonomous vehicle that makes use of a machine learning model, trained with mixed integer programming, to perform driving actions, in accordance with an embodiment of the present invention;

FIG. 5 is a diagram of an exemplary neural network architecture that can be used to implement part of a machine learning model, in accordance with an embodiment of the present invention;

FIG. 6 is a diagram of an exemplary deep neural network architecture that can be used to implement part of a machine learning model, in accordance with an embodiment of the present invention; and

FIG. 7 is a block diagram of a computing environment that can be used to train a model with mixed integer programming, in accordance with an embodiment of the present invention.

### DETAILED DESCRIPTION

Mixed integer programming can be used to optimize the weight parameters of deep neural networks. The weight parameters are treated as variables, through constructing constraints and objective functions, to accelerate the optimization efficiency in a target-oriented manner. In contrast to backpropagation, which relies heavily on hardware resources such as processing power and memory, the result, the amount of computation needed on external hardware resources is also reduced. The efficiency of the weight parameter optimization in backpropagation is based on the computation of a loss function to determine an error value based on discrepancies between the predicted label and the predetermined class label, and a complex loss function can hamper the efficiency of the training. Additionally, a deep neural network architecture can suffer from vanishing gradients or exploding gradients.

Weight parameters of a neural network are converted to variable vectors in a mixed integer programming problem. An objective function is selected, which may be simpler than that which would be used for backpropagation, and optimization calculates the weight parameters from the deep neural network. Evaluation metrics are used to constrain the optimization of an objective function. In some embodiments, although gradient calculations are not needed for the mixed integer programming optimization, the objective function may include the loss function from the backpropagation process, along with appropriate integer constraints such as weight quantization and structure selection.

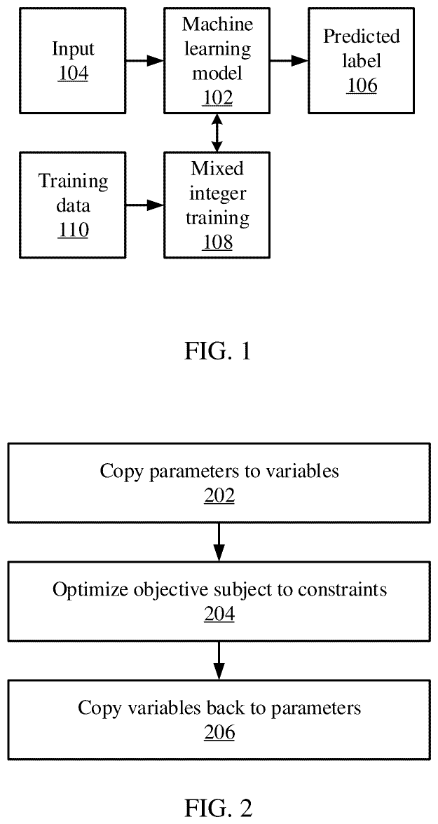

Referring now to FIG. 1, a block diagram showing the use of mixed integer programming in training a machine learning model 102 is shown. The machine learning model 102 may be, for example, a deep neural network that accepts input data 104 and generates a predicted label 106. For a linear model, this may be represented as a classification function ƒ(x)=wx+b, where x is an input, w is a parameter matrix, and b is a constant. The label 106 may be a multi-class label, which can label the input 104 according to any appropriate number of different classes, or a binary label, which distinguishes between two classes. The input 104 may be any appropriate data type, such as textual data, image data, or time-series sensor data.

While the structure of the machine learning model 102 does not change during training, the parameters do. The machine learning model 102 may be initialized with a set of initial parameters, for example by setting to a constant value (e.g., zero) or random values. In some cases the machine learning model 102 may be pre-trained, with parameters that have been preset to some effective values. Such a pre-trained model may be fine-tuned in accordance with additional training data. The parameters of the machine learning model 102 are modified during mixed integer programming-based training 108, which uses a set of training data 110.

Training is an iterative process. The mixed integer programming-based training 108 constructs a set of variables based on the current parameters of the machine learning model 102. A training objective is determined for the machine learning model 102 based on the task it is designed to perform, and associated constraints are created. The mixed integer programming-based training 108 optimizes the training objective, subject to the one or more constraints, to generate new parameters for the machine learning model 102. These new parameters may be used for a subsequent training iteration or may be used to perform inference on a novel input 104 to generate a label prediction 106.

Mixed integer programming is an approach to optimization that can simultaneously process both integer and continuous variables. The parameters of a neural network model may be, in general, expressed as real-valued numbers. The present embodiments re-express one or more of these parameters as integer valued variables, which can be processed more efficiently than the real-valued parameters.

A mixed integer program (MIP) is defined by its variables, objectives, and constraints. Different types of information may be captured by the variables, including yes/no information and categorical information, in addition to real-valued measurements. The weight parameters of the machine learning model 102 are thus used as the initial variables xu for the MIP optimization, where I is a layer of the machine learning model 102 and i is an index of a corresponding layer weight parameter. Other optimized parameters, e.g., hyperparameters, may also be translated to variables, such as batch size.

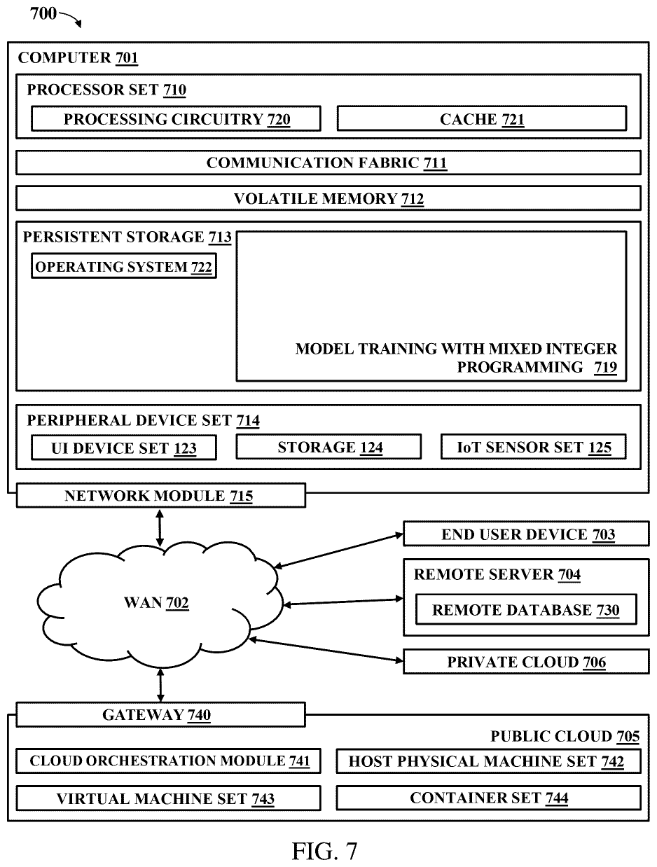

Referring now to FIG. 2, a method of performing MIP training is shown. Block 202 copies the parameters of the machine learning model 102 over to variables xu. Using these variables as a starting point, block 204 performs an optimization subject to constraints. The optimization attempts to optimize an objective function, such as:

$$max {\sum }_{i = 1}^{n} {Z}_{i}$$

where Zᵢ is 1 if a predicted label for training data i is equal to the predetermined class label and is 0 otherwise. Variable n represents the size of the dataset. Another example of an objective function may aim to minimize the sum of squared prediction errors:

$$min \frac{1}{2} {\sum }_{i = 1}^{N} ( {wx}_{i} + b - {y}_{i} )$$

where yᵢ is a ground truth value for the i^{th} training sample. The objective function is determined based on the task for the machine learning model 102 and its goals. For example, the objective function may be selected to maximize classification accuracy. In some embodiments, a human subject matter expert performs the selection of the objective function. For example, for machine learning tasks that involve resource allocation and/or selection problems, the first objective function described above may be selected. For machine learning tasks that are related to regression, then the second objective function described above is selected. A human subject matter expert may perform the selection of the objective function when constraints need to be considered and/or if a multi-objective optimization needs to be considered. In some embodiments, an automated software program performs the selection of the objective function in response to receiving one or more of machine learning tasks, constraints, and goals that are input, e.g., into a graphical user interface associated with automated software such as model training with mixed integer programming 719 (shown in FIG. 7) that performs the inventive methods. In such embodiments, the automated software implements heuristics to perform selection of the objective function. In some embodiments, the mixed integer programming 719 includes a machine learning model that has been trained to perform selection of the objective function in response to receiving input regarding a model task and one or more constraints for the objective function. Training data used to train this machine learning model includes sets of model tasks and constraints as input and then an appropriate objective function (that matches a particular model task and one or more constraints) as a label for a particular set. The training in some embodiments includes backpropagation to adjust parameters of this machine learning model to correctly predict the label.

The optimization of block 204 may be performed subject to constraints. Constraints may include setting upper and lower bounds for the variables, setting loss bounds for the corresponding loss values, and specifying that certain variables have integer values. In the example of the second objective function described above, a constraint may be:

$${‖ w ‖}_{2}^{2} < λ$$

where λ is a threshold value.

Any appropriate optimization technique may be used to solve the optimization problem of block 204. For example, the objective function may be re-expressed as its Lagrangian dual and then solved. In some cases, a closed-form solution may be available. In other cases, a solver may be used, or projected gradient descent may be applied. Regardless of the optimization technique, the variables will be modified to optimize the objective function subject to the constraints, including the constraint that at least one particular variable will be an integer value. Block 206 then copies the variables back into the machine learning model 102, including setting weight parameters to their corresponding new variable values, and further setting hyperparameters such as batch size similarly. Certain parameters of the machine learning model may be integer-valued, and in this case the hyperparameters of the machine learning model may similarly be transferred to the mixed integer programming problem as variables. Thus, if the hyperparameters are integer-valued, their corresponding variables may be constrained to be integer-valued during the optimization. This type of mixed integer programming-based optimization can be more efficient than conventional backpropagation, for example in smaller model sizes. Notably the trained machine learning model that is produced has been trained without performing backpropagation.

In some examples, the constraints may be selected according to the needs of the particular task. For example, when using mixed integer programming to train an autonomous driving model, a constraint may be used that limits the loss under input perturbations to be within a safety threshold. Following this example, low-quality images resulting from fog or dust may be excluded from the training. Other examples may limit the loss under adversarial perturbations or may limit prediction error disparities across groups.

As noted above, the constraints may indicate specific integer-constrained variables which encode discrete decisions. Examples of such variables may include variables indicating layer retention and a total number of layers in a neural architecture search, weight quantization for particular weights, and task-core allocation for hardware mapping. These integer values can be used in a binary neural network, where weights are limited to zero or one, or in model pruning, where the values of zero and one may indicate whether a given neuron is pruned or retained.

Referring now to FIG. 3, a method of training and using a machine learning model is shown. Block 300 performs model training, in particular using MIP optimization 302, such as by the method shown and described in FIG. 2. The initial parameters of the model are transformed to variables of a mixed integer programming problem, the mixed integer programming problem is solved according to an objective function and constraints, and the resulting variables are copied back to the parameters of the machine learning model.

Block 310 then deploys the model. Model deployment may include copying the machine learning model and its parameters to a target system, which will receive new data and perform an appropriate task. In circumstances where the model is trained at the same system where it will be used, the step of model deployment may be omitted.

Block 320 performs a task using the trained model. For example, the model may be designed to perform a task related to the operation of an autonomous vehicle, such as object or person detection. New data may be acquired from system sensors, such as from a vehicle's cameras, and the model may operate on the new data to perform its task. Following the example of person detection, the model may analyze an input image to identify a person and their location by outputting an associated bounding box. Based on this information, block 330 may perform a responsive action. In the example of an autonomous vehicle, the responsive action may include the computer of the autonomous vehicle autonomously causing a braking, accelerating, or steering action to avoid a person, vehicle, or road hazard. Although the example of autonomous driving is described in detail herein, it should be understood that the present principles may apply to any sort of machine learning model and associated task.

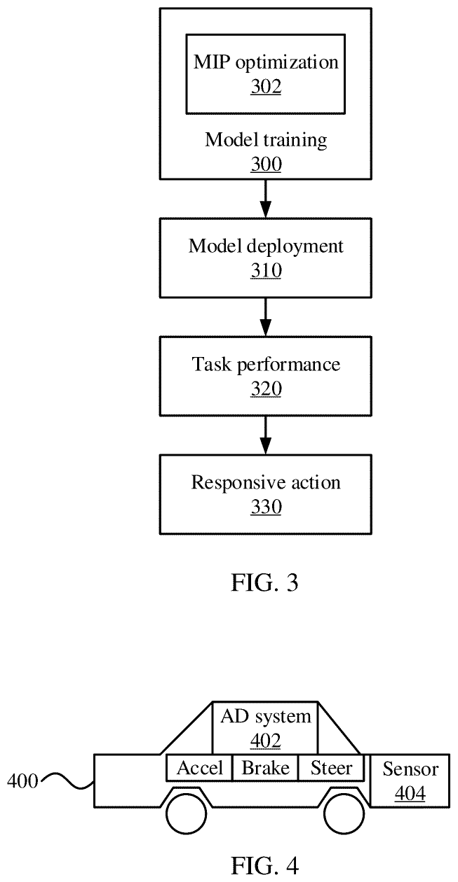

Referring now to FIG. 4, a vehicle 400 with an automated driving system 402 is shown. The automated driving system 402 interfaces with various systems in the vehicle 400, including acceleration/throttle systems, braking systems, and steering systems. The automated driving system 402 can furthermore interface with other vehicle systems, for example engaging or disengaging systems such as traction control, four-wheel drive, global positioning satellite receiving, and any other systems relating to navigation and control for the vehicle 400. The automated driving system 402 can be fully autonomous, accepting no driver input, or can be partially autonomous, where only some vehicle systems are controlled or where control can be overridden by a driver.

The systems of the vehicle 400 are limited in terms of their ability to change the vehicle's state. For example, the acceleration and braking systems are limited in the acceleration they can exert on the vehicle 400, and the steering systems are limited in their turning radius and response speed. These different factors dictate how the vehicle 400 can move on the road within a given time period, providing the range of possible actions that the automated driving system 402 can take.

It should be understood that the term “vehicle” is used herein to refer to many different kinds of vehicles, including passenger vehicles and cargo vehicles. It should further be understood that the term “vehicle” is not limited to automobiles and other motorized conveyances, but can also include human-powered vehicles, such as bicycles.

As the vehicle 400 navigates on a roadway, it will encounter a variety of obstacles. Some of these obstacles are fixed in place, such as traffic control devices, while others may be in motion, such as road debris and other vehicles. The vehicle 400 includes one or more sensors 404 that sense the presence of obstacles on the road. The sensors 404 may include cameras and/or light detection and ranging (LIDAR) sensors. The sensors 404 have a certain range, within which they are able to reliably detect the presence of an obstacle. The information from the sensors 404 may be provided as input to the automated driving system 402, which uses them to identify the present state of the vehicle 400 and the environment that it operates within.

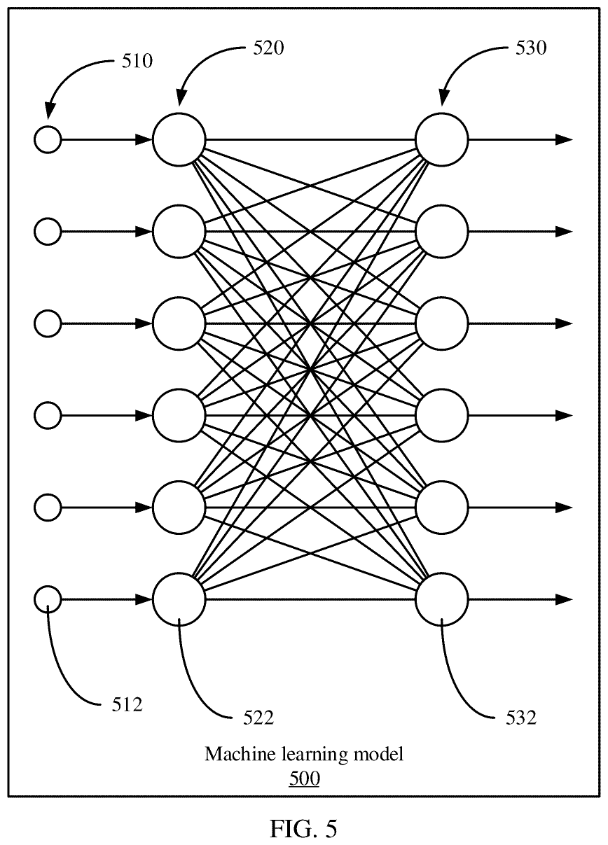

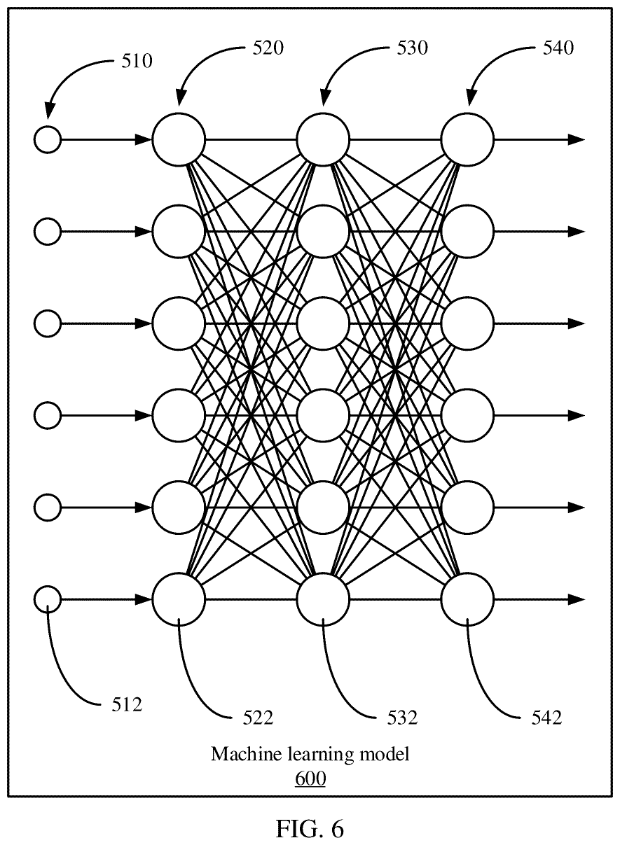

Referring now to FIGS. 5 and 6, exemplary neural network architectures are shown, which may be used to implement parts of the present models, such as the machine learning model 500/600. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

Shifting to the embodiment shown in FIG. 6, a deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as model training with mixed integer programming 719. In addition to block 719, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 200, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 200 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715. WAN 702 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES (not separately shown in FIG. 7): private and public clouds 706 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of weight parameter optimization using mixed integer programming (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method, comprising:
copying first parameters of a machine learning model into variables of a mixed integer programming problem, including at least one variable that is constrained to be an integer value;
solving the mixed integer programming problem, using a hardware processor, according to an objective function and one or more additional constraints to generate trained variables; and
copying the trained variables into the machine learning model to replace the first parameters and to create a trained machine learning model.

2. The method of claim 1, wherein solving the mixed integer programming problem is used to train the machine learning model without backpropagation.

3. The method of claim 1, wherein the at least one variable that is constrained to be an integer value includes a parameter of a binary neural network.

4. The method of claim 1, wherein the at least one variable that is constrained to be an integer value determines neuron pruning.

5. The method of claim 1, wherein the at least one variable that is constrained to be an integer value is a hyperparameter of the machine learning model.

6. The method of claim 1, further comprising performing a task using the trained machine learning model and performing an action responsive to the task.

7. The method of claim 6, wherein the task includes object detection and the action is selected from the group consisting of an accelerating action, a braking action, and a steering action by an automated driving system in a vehicle.

8. A computer system, comprising:
a processor set;
one or more computer-readable storage media; and
program instructions stored on the one or more computer-readable storage media to cause the processor set to perform operations comprising:
copying first parameters of a machine learning model into variables of a mixed integer programming problem, including at least one variable that is constrained to be an integer value;
solving the mixed integer programming problem, using a hardware processor, according to an objective function and one or more additional constraints to generate trained variables; and
copying the trained variables into of the machine learning model to replace the first parameters and to create a trained machine learning model.

9. The computer system of claim 8, wherein solving the mixed integer programming problem is used to train the machine learning model without backpropagation.

10. The computer system of claim 8, wherein the at least one variable that is constrained to be an integer value includes a parameter of a binary neural network.

11. The computer system of claim 8, wherein the at least one variable that is constrained to be an integer value determines neuron pruning.

12. The computer system of claim 8, wherein the at least one variable that is constrained to be an integer value is a hyperparameter of the machine learning model.

13. The computer system of claim 8, further comprising performing a task using the trained machine learning model and performing an action responsive to the task.

14. The computer system of claim 13, wherein the task includes object detection and the action is selected from the group consisting of an accelerating action, a braking action, and a steering action by an automated driving system in a vehicle.

15. A computer program product, comprising:
one or more computer-readable storage media; and
program instructions stored on the one or more computer-readable storage media to perform operations comprising:
copying first parameters of a machine learning model into variables of a mixed integer programming problem, including at least one variable that is constrained to be an integer value;
solving the mixed integer programming problem, using a hardware processor, according to an objective function and one or more additional constraints to generate trained variables; and
copying the trained variables into the machine learning model to replace the first parameters and to create a trained machine learning model.

16. The computer program product of claim 15, wherein solving the mixed integer programming problem is used to train the machine learning model without backpropagation.

17. The computer program product of claim 15, wherein the at least one variable that is constrained to be an integer value includes a parameter of a binary neural network.

18. The computer program product of claim 15, wherein the at least one variable that is constrained to be an integer value determines neuron pruning.

19. The computer program product of claim 15, wherein the at least one variable that is constrained to be an integer value is a hyperparameter of the machine learning model.

20. The computer program product of claim 15, further comprising performing object detection using the trained machine learning model and performing an action responsive to the object detection, the action being selected from the group consisting of an accelerating action, a braking action, and a steering action by an automated driving system in a vehicle.
